(19) United States
(12) Patent Application Publication
(10) Pub. No.: US 2021/0020149 A1
(43) Pub. Date: Jan. 21, 2021

(54) Intelligent system for matching audio with video

(71) Applicant: Tzu-Hui Li, TAIPEI CITY (TW)

(72) Inventor: Tzu-Hui Li, TAIPEI CITY (TW)

(21) Appl. No.: 16/749,195

(22) Filed: Jan. 22, 2020

(30) Foreign Application Priority Data
Jul. 15, 2019 (TW) 108124933

(51) Int. Cl. G10H 1/00; G10L 15/22; G10L 15/08; G11B 27/031

(52) U.S. Cl. CPC G10H 1/0008; G10L 15/22; G10L 15/08; G11B 27/031; G10L 2015/088; G10H 2210/076; G10H 2210/071; G10H 2210/036; G10H 2210/056

(57) ABSTRACT

An intelligent system for matching audio with video of the present invention provides a video analysis module targeting color tone, storyboard pace, video dialogue, length and category and director's special requirement, actors expression, movement, weather, scene, buildings, spacial and temporal, things and a music analysis module targeting recorded music form, sectional turn, style, melody and emotional tension, and then uses an AI matching module to adequately match video of the video analysis module with musical characteristics of the music analysis module, so as to quickly complete a creative composition selection function with respect to matching audio with a video.

### BACKGROUND OF THE INVENTION

### a) Field of the Invention

The present invention relates to an intelligent system for matching audio with video, and more particularly to a music editing system for matching audio with video by means of AI matching.

### b) Description of the Prior Art

For a singer, a music professional, album production personnel, single track production personnel, a record company or a media company who are concerned with providing music information, when selecting a creative composition for a produced video, it is usually up to a music professional, a video provision authority or a music application authority to select a composition, and matching audio with video is usually completed by video editing and production personnel such as an advertisement company, a movie trailer production team, a movie company, a film production student, photographer-produced photograph audio matching personnel, a theatrical company, a dance theater company, a game company, web page design music personnel, business promotion soundtrack personnel, event background music personnel, event live performance personnel, show music personnel, exhibit music personnel, interactive design music personnel, AR/VR interactive device music personnel and multimedia personnel; alternatively, the described entities who require applications of music would commission other music application units to select a composition, or commission music production/audio matching personnel, a studio, a creator, a singer, a music professional, album production personnel, single track production personnel, a record company or a media company/unit to compose music therefor. However, the described users who require music, for example, a music application authority such as a video production entity or a theatrical creation entity, often face various issues regarding music authorization. For instance, a simple act of uploading a favorite video to YouTube could result in copyright infringement and even lead to a YouTube account being deleted. When the described music information provider intends to look for audio to be matched with a video and copyright authorization, the process is extremely time consuming and will take from 8 hours to 6 months for selecting compositions, listening to the compositions and seeking authorization in order to find decent audio to be matched with the video. For a video creative composition selection unit, it would take a music application creator approximately 5 hours to select a composition each time and approximately 5 days to commission production each time, and the copyright signing process is extremely cumbersome. For a music copyright transaction unit, it would take approximately 5 hours to look for a composition each time and approximately 6 months to sign for copyright; the allocation of royalty is often not properly done in most circumstances. Therefore, for most people who seek applications of music or video creators, an issue which requires an urgent solution is to enable a composition selection time for video creation and a music copyright purchase and authorization time to be significantly reduced for a video professional matching audio with video or a theatrical company creating a play.

An intelligent system for matching audio with video is provided for enabling a unit related to seeking music authorization, such as a video production unit, a theatrical company and the like, to bypass various issues encountered while selecting a composition for video creation.

### SUMMARY OF THE INVENTION

The primary object of the present invention is to provide an intelligent system for matching audio with video, which use an AI matching module to connect to a video analysis module and a music analysis module, so as to perform adequate matching between video and musical characteristics and recommend several songs for matching; if the recommended songs are not satisfactory, new recommendations of other songs can be made for matching, so as to achieve the object of quickly selecting a composition for video creation by means of intelligent matching.

### BRIEF DESCRIPTION OF THE DRAWINGS

FIG. 1 shows a system block diagram according to the present invention.

FIG. 2 shows a schematic view of color analysis in a current video analysis.

FIG. 3 shows a schematic view of emotional parameters in a current music analysis.

FIG. 4 shows a schematic view of audio matching reference information for an intelligent system for matching audio with video according to the present invention.

FIG. 5 shows a flow chart of audio matching modes for the intelligent system for matching audio with video according to the present invention.

FIG. 6 shows another system block diagram according to the present invention.

### DETAILED DESCRIPTION OF THE PREFERRED EMBODIMENTS

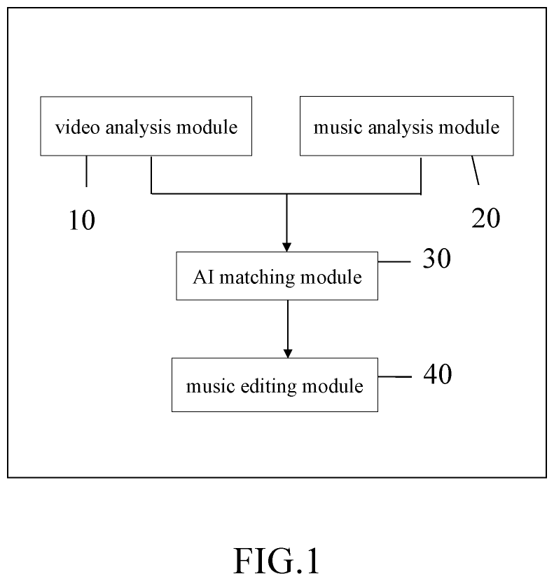

Referring to FIG. 1, a system of the present invention comprises a video analysis module 10, a music analysis module 20, an AI matching module 30 and a music editing module 40.

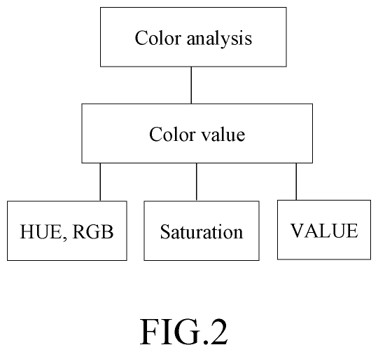

The video analysis module 10 makes an analysis according to color tone, storyboard pace, video dialogue (such as a plot, a word of turn in speech and the like), length and category, director's special requirement and characteristic, actors expression, movement, weather, scene, buildings, spatial and temporal factors, things, creature, character, character personality; video content analysis of the video analysis module 10 includes: a color analysis, a content analysis and a character expression analysis. Referring to FIG. 2, which shows a structure of color analysis categories for analyses of color function, color value; a content analysis distinguishes who, how, when, where and what (such as a year, a location, a time, a plot and the like) based on a scene, a person, an item and lighting in a video; a character expression analysis determines an emotion of a person, a plot, a likely conversation and the like in a video according to an expression; by combining the described video content analysis, vector values of various videos can be obtained respectively. A storyboard file analysis for processing storyboard pace in the video analysis module 10 is made according to a time point of the storyboard pace, and a mode is then input to serve as a reference for time point recording, and music and sound effect insertion points between scene switches. The storyboard file analysis obtains a time in seconds for each storyboard, which can be used to make an analysis or an on-point design on each storyboard content; a sound effect or a storyboard list in a music matching analysis of the video analysis module 10 and the music analysis module 20 can be used to collect a Word storyboard file and a video itself in a frame-by-frame analysis. A character-based analysis related to a video dialogue in the video analysis module 10 is made according to a video dialogue and a plot, and the video dialogue is processed to look for a storyline or delete a word of turn in speech, so as to clearly present keywords and arrange the same according to dependency (or influence), and proportionally locate a corresponding emotional parameter on average, a current Mandarin emotion dictionary is used to make a textual analysis. When the video analysis module 10 processes a director's special requirement, a special requirement made by the director is weighted on an order of a result (a proportion of influence on the result from said factor is greater).

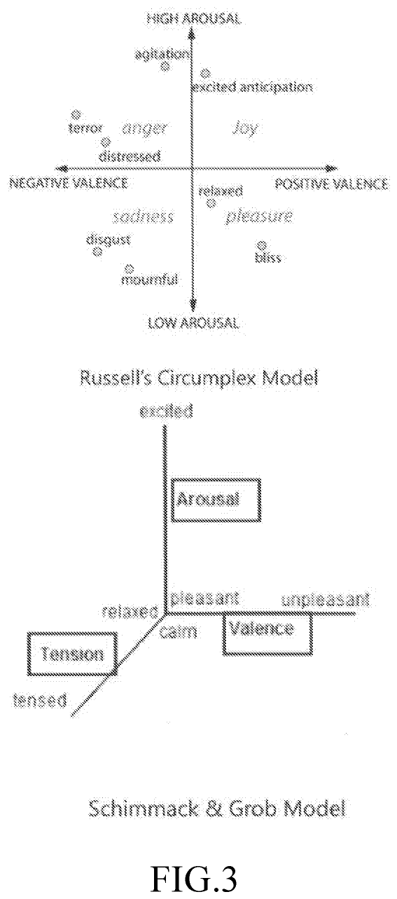

The music analysis module 20 makes an analysis according to recorded music form, sectional turn, style, genre, melody, tempo, instrument, chord accompaniment, voice type, rhythm, volume and emotional tension; a music analysis and content of the music analysis module 20 includes: a music property analysis, an emotion analysis and music characteristic information, wherein the music property analysis is related to an analysis of musical tone property, instrumental arrangement, music structure, rhythm, chord, chord progression, rhythm notes, pitch, scale progression, style, music form, section, phrase, lyrical phrase, genre and other music file information. Referring to FIG. 3, shows a schematic view of emotional parameters in a current music analysis, an emotional parameter (x, y) of the emotion analysis at different time points of each song is recorded by means of machine training and intelligent learning according to musical content; wherein an x axis (Valence) of the emotional parameter shows positive and negative values of emotions (a positive value indicates a positive inclination, and a negative value indicates a negative inclination), and a y axis (Arousal) of the emotional parameter shows an excitement level of an emotion. Music information is derived from a singer, a music professional, album production personnel, single track production personnel, a record company, a media company, OP, SP, a regional organization, a copyright collective management organization, a copyright, a contractual relationship, a recorded music length, a style, a file location, an open region, a streaming link, a download link, a video link, a midi file, a way file and a mp3 file; in addition, a reference music analysis in the music analysis module 20 is related to input preferred reference music and program, and the input reference music is used to make a music analysis to locate a title matched with an analysis result in a database.

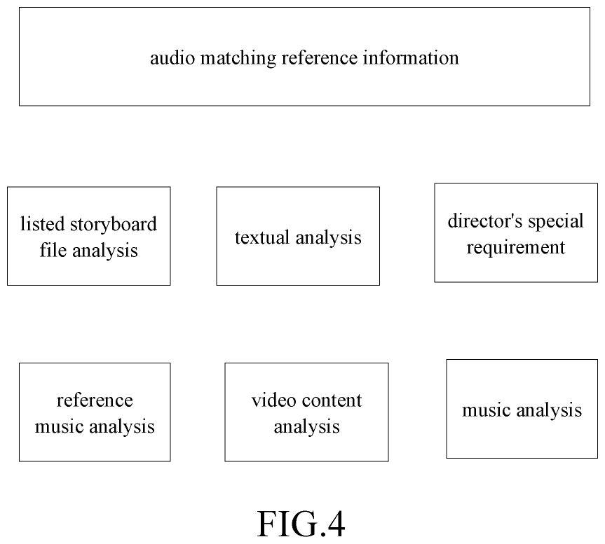

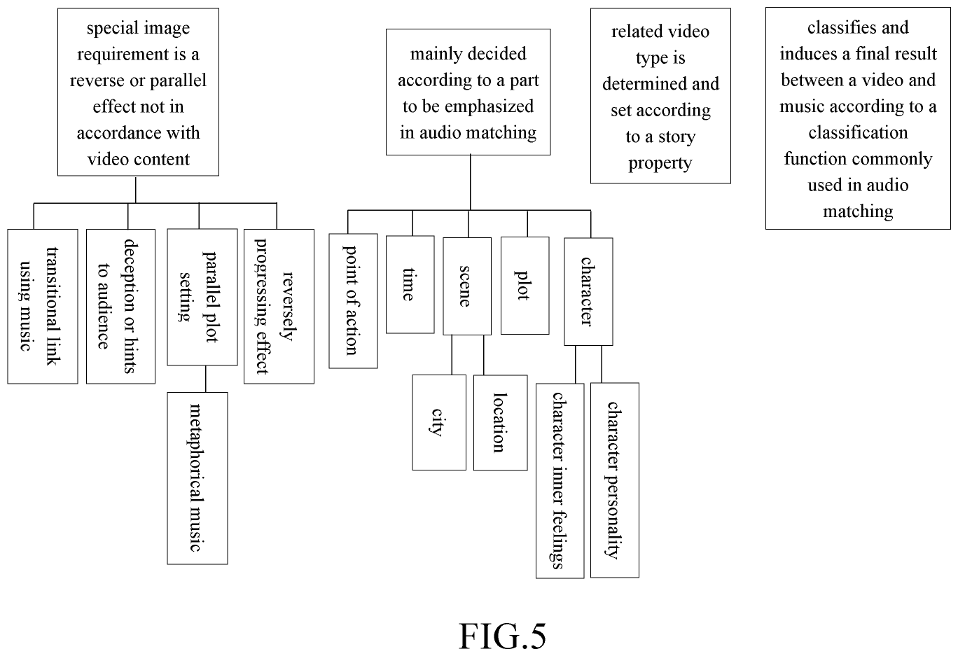

Referring to FIG. 4, shows a schematic view of audio matching reference information for an intelligent system for matching audio with video according to the present invention, the present invention obtains a corresponding value by means of the listed storyboard file analysis, textual analysis, the director's special requirement, reference music analysis, video content analysis and music analysis, and then correspondingly matches a value of a video with music. Referring to FIG. 5, shows a flow chart of audio matching modes for the intelligent system for matching audio with video according to the present invention, the present invention classifies and induces a final result between a video and music according to a classification function commonly used in audio matching, wherein a related video type is determined and set according to a story property, and is mainly decided according to a part to be emphasized in audio matching; for example, a character (including a character personality and inner feelings), a plot, a scene (including a location or a city), a time, a point of action and the like; a special picture requirement is a reverse or parallel effect not in accordance with video content, such as a reversely progressing effect, parallel plot setting (or reference music), deception or hints to audience, a transitional link using music and the like.

The present invention of the intelligent system for matching audio with video is characterized in: an AI matching module 30 for connecting to the video analysis module 10 and the music analysis module 20, so as to perform adequate matching between a video and a musical characteristic and recommend five songs for matching in practice; if the recommended songs are not satisfactory, new recommendations of other songs can be made for matching. The music editing module 40 is connected to the AI matching module 30, and the present invention can be used to impeccably match a time axis with an impact point between a music file and a video file by means of clip cutting and editing, music editing, music volume adjustment and sound field simulation. With regard to point-to-point matching of sound effects between the music editing module 40 and the music analysis module 20, in video data referred thereby, there can be more sound effects, so that an insertion point for a sound effect can be obtained by analyzing a waveform.

The video data referred to by the AI matching module 30 trained by the present invention includes: YouTube-Movie, YouTube-movie clips and the like.

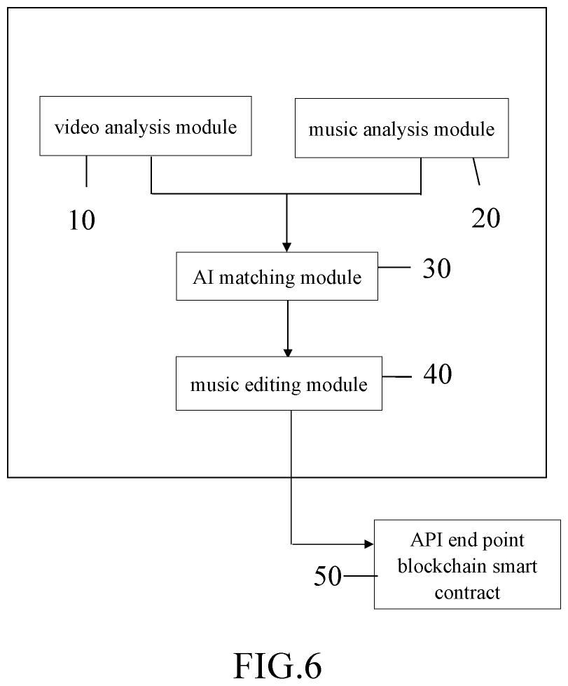

Referring to FIG. 6, shows another system block diagram according to the present invention, a system of the present invention comprises a video analysis module 10, a music analysis module 20, an AI matching module 30 and a music editing module 40. The intelligent system for matching audio with video of the present invention can use an API end point blockchain smart contract 50 to link to the music editing module 40, so as to achieve freedom in use by authorization. The API end point blockchain smart contract 50 signed with a music professional can be used to collaboratively sell music to a video professional, said sell music to a video professional can also be a section or a track division, assuming that the music is from a song produced by a rock band and the song includes sounds of an electric guitar, a person, a drum or an electric bass, by using a program of the intelligent system for matching audio with video of the present invention, music of a pure drum sound of the song, from a track of another song or from a track of an electric guitar can be mixed together with the program of the intelligent system for matching audio with video of the present invention for processing.

A search for related keywords in a database page includes: a title, a genre, a style, a tempo, an instrument, a related keyword, an artist, an emotion, a cover photo and the like; an unique function of an audio signal is related to formats such as a mp3, a way format or mp3 format and the like; related authorization and an order are related to commercial behaviors such as an estimated order amount based on Loop, midi and music authorization, making an order, updating an order, downloading purchased music and the like.

An algorithm of the AI matching module 30 of the present invention includes:

a filtering and selecting mode and a scoring mode, wherein the filtering and selecting mode is within a range of standard deviation for normal distribution, so as to provide a criterion for whether to select or not, a value within a 68% confidence interval (within the error range of one standard deviation) is allowed, and a category of said filtering and selecting comprises a genre or an emotional parameter and the like. The scoring mode quantifies categories such as rhythm, instrument arrangement, chord, musical emotion (x, y), keyword emotion (x, y), director-input information, main video color tone, video content and the like, so as to calculate a score for each item for performing weighting and averaging.

In conclusion, the intelligent system for matching audio with video of the present invention, the AI matching module is mainly used to connect to the video analysis module and the music analysis module, so as to adequately match a video with a musical characteristic; after diverse logging in by a video company, selecting a video and reviewing by a director, as long as an API end point blockchain smart contract is established on the platform, a music professional, a video company and a media company are enabled to quickly complete matching audio with video.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An intelligent system for matching audio with video, comprising:
a video analysis module for making an analysis according to color tone, storyboard pace, video dialogue, length and category, director's special requirement, and characteristic, actors expression, movement, weather, scene, buildings, spatial and temporal factors, things, creature, character, character personality;
a music analysis module for making an analysis according to recorded music form, sectional turn, style, genre, melody, tempo, instrument, chord accompaniment, voice type, rhythm, volume and emotional tension, wherein said music analysis and content comprise a music property analysis, an emotion analysis and music characteristic information;
an AI matching module for connecting to the video analysis module and the music analysis module so as to adequately match a video with a musical characteristic; and
a music editing module connected to the AI matching module, so as to impeccably match a time axis with an impact point between a music file and a video file by means of clip cutting and editing, music editing, music volume adjustment and sound field simulation.

2. The intelligent system for matching audio with video according to claim 1, wherein the video analysis module comprises an analysis of a color function and a color value in a movie, a color analysis of a structure of color analysis categories, a content analysis of a scene, a person, an item and lighting for distinguishing who, how, when, where and what in a video, and a character expression analysis for determining an emotion, a plot and a likely conversation of characters in a video according to an expression.

3. The intelligent system for matching audio with video according to claim 1, wherein the video analysis module has a storyboard file analysis for processing a storyboard pace according to a time point of the storyboard pace, and then a mode is input to serve as a reference for time point recording, music and sound effect insertion points between scene switches.

4. The intelligent system for matching audio with video according to claim 1, wherein the video analysis module has a character-based analysis handling a video dialogue according to a video dialogue and plot analysis, and processes the video dialogue to look for a storyline or delete a word of turn in speech, so as to clearly present a keyword and arrange the same according to dependency (or influence), and proportionally locate a corresponding emotional parameter on average.

5. The intelligent system for matching audio with video according to claim 1, wherein the music analysis module has a music property analysis for analyzing musical tone property, instrumental arrangement structure, rhythm, chord, chord progression, rhythm pitch, scale progression, style, music form, section, phrase, lyrical phrase, genre and other music file information.

6. The intelligent system for matching audio with video according to claim 1, wherein the music analysis module has an emotion analysis for recording an emotion parameter (x, y) at different time points of each song by means of machine training and intelligent learning according to musical content, wherein an x axis (Valence) of the emotional parameter shows a value of a positive emotion and a y axis (Arousal) of the emotional parameter shows an excitation level of a negative emotion.

7. The intelligent system for matching audio with video according to claim 1, wherein the music analysis module has music characteristic information derived from a singer, a music professional, album production personnel, single track production personnel, a record company, a media company, OP, SP, a regional organization, a copyright collective management organization, a copyright, a contractual relationship, a recorded music length, a style, a file location, an open region, a streaming link, a download link, a video link, a midi file, a way file and a mp3 file.

8. The intelligent system for matching audio with video according to claim 1, wherein an algorithm of the AI matching module includes: a filtering and selecting mode and a scoring mode and a editing mode.

9. The intelligent system for matching audio with video according to claim 8, wherein the filtering and selecting mode is within a range of standard deviation for normal distribution, so as to provide a criterion for whether to select or not, a value within a 68% confidence interval (within the error range of one standard deviation) is allowed, and a category of said filtering and selecting comprises a genre or an emotional parameter and the like.

10. The intelligent system for matching audio with video according to claim 8, wherein the scoring mode quantifies categories such as rhythm, instrument arrangement, chord, musical emotion (x, y), keyword emotion (x, y), director-input information, main video color tone, video content and the like, so as to calculate a score for each item for performing weighting and averaging.
